(19) United States
(12) Patent Application Publication
(10) Pub. No.: US 2015/0361004 A1
(43) Pub. Date: Dec. 17, 2015

(54) FERTILIZER USING CRUSHED STONE POWDER AND MANUFACTURING METHOD THEREOF

(71) Applicants: Ji Ho KANG, Gunsan-si (KR); ART STONE CO., LTD, Iksan-si (KR)

(72) Inventors: Ji Ho KANG, Gunsan-si (KR); Deuk Ju KIM, Iksan-si (KR); Hyeon Jin KIM, Iksan-si (KR)

(21) Appl. No.: 14/573,051

(22) Filed: Dec. 17, 2014

(30) Foreign Application Priority Data
Jun. 12, 2014 (KR) 10-2014-0071138

(51) Int. Cl. C05D 1/00

(52) U.S. Cl. CPC C05D 1/00

(57) ABSTRACT

Disclosed are a fertilizer using a crushed stone powder and a method of manufacturing the same. The fertilizer includes a crushed stone powder at a ratio of 10 wt % to 50 wt %, a microbe at a ratio of 1 wt % to 20 wt %, a yellow residual soil powder at a ratio of 10 wt % to 50 wt %, dried livestock manure at a ratio of 10 wt % to 20 wt %, and a bulking agent at a ratio of 10 wt % to 30 wt %.

### BACKGROUND OF THE INVENTION

1. Field of the Invention

The present invention relates to a fertilizer using a crushed stone powder and a method of manufacturing the same, and more particularly, to a fertilizer using a crushed stone powder, which is capable of supporting the growth and quality of crops and improving soil by adding livestock manure and a microbe to a crushed stone powder, which is produced during a process of a stone product and treated as waste, to increase absorption force of the inorganic substances contained in the crushed stone powder and supply organic substances, and a method of manufacturing the same.

2. Description of the Related Art

In general, most of stone products used in architecture and civil engineering are treated in a stone product factory and are suitably manufactured for use purpose through a talc grinding and cutting process.

A great quantity of sludge of crushed stone power of a particulate type is produced during the process of producing a stone product described above. A part of the crushed stone power sludge produced during the producing process is reused for filling a livestock shed, but most of the crushed stone power sludge is treated as waste because the crushed stone power sludge has no particular use.

The crushed stone power sludge must be thrown away after being mixed with an amount of soil at a constant ratio in order to treat the crushed stone power sludge, but there are many cases that the crushed stone power sludge is left away in an open storage state because any places suitable for treating the crushed stone power sludge do not exist. For this reason, atmosphere environment worsens due to a scatter of the crushed stone power, so that breathing disorder may be caused and health hygiene such as pneumoconiosis, working environment and working efficiency may be deteriorated. In addition, when the crushed stone power is buried in the ground, soil may be devastated and financial burden of securing land may be caused.

As industry has been developed, the demand for stone products has been exponentially increased. Thus, the crushed stone powder is left away near a factory for processing stones without permission, so that the crushed stone powder may be washed away with rainwater to form a stone powder membrane after a heavy rain or flood and a storm pass therethrough, so any fishes and hydrophytes may not survive any longer.

Meanwhile, farm land for cultivating crops has been acidified due to the use of a large of quantity of fertilizer for the purpose of crop harvest and acid rain. To overcome the above problems, a quality of soil may be improved through soil replacement, but it is costly to perform the soil replacement.

To utilize a crushed stone powder, as related arts of the present invention, there are disclosed Korea Patent Register No. 10-1234923 entitled “Concrete panel composition for compression molding using crushed stone powder, and compression molding panel manufactured with the same”, Korea Patent Register No. 10-0922375 entitled “Method of manufacturing porous calcium silicate hardening material using crushed stone powder or crushed stone powder sludge”, and Korea Patent Register No. 10-0579811 entitled “Method of manufacturing artificial stone using crushed stone powder”. However, any technique for manufacturing an environment-friendly fertilizer, which is capable of supplying nourishment to crops by adding livestock manure and a microbe to a crushed stone powder, is not disclosed in the related arts described above.

### SUMMARY OF THE INVENTION

The present invention has been made to solve the above problems occurring in the related art, and an object of the present invention is to provide a fertilizer using a crushed stone powder, which is capable of supporting the growth and quality of crops and improving soil by adding livestock manure and a microbe to a crushed stone powder, which is produced during a process of a stone product and treated as waste, to increase absorption force of the inorganic substances contained in the crushed stone powder and supply organic substances, and a method of manufacturing the same.

To achieve the object, according to the present invention, there is provided a fertilizer using a crushed stone powder, which includes a crushed stone powder at a ratio of 10 wt % to 50 wt %, a microbe at a ratio of 1 wt % to 20 wt %, a yellow residual soil powder at a ratio of 10 wt % to 50 wt %, dried livestock manure at a ratio of 10 wt % to 20 wt %, and a bulking agent at a ratio of 10 wt % to 30 wt %. The crushed stone powder has a diameter in a range of 0.01 μm to 30 μm and a specific surface area in a range of 5 m²/g to 45 m²/g. The microbe includes at least one selected from streptomyces albulus, pseudomonas cepacia, zymomonas mobilis, saccharomyces cerevisiae, and trichoderma viride. The bulking agent includes at least one selected from a husk, sawdust, straw, scob and paste

According to the present invention proposed above, the fertilizer using a crushed stone powder may be utilized as environment-friendly crop nutritional supplements by supplying potassium (K), nitrogen (N) and phosphorus (P) required for growing crops with potassium (K) contained in the crushed stone powder and nitrogen (N) and phosphorus (P) contained in livestock manure.

In addition, the growth and quality of crops may be increased by the useful microbe added when manufacturing the fertilizer by using the crushed stone powder, and soil may be improved due to the degradation action of microbe, so that the fertilizer may be utilized as an environment-friendly soil improvement agent.

In addition, the fertilizer may be manufactured by using a wasted crushed stone powder, so that waste is reused. Further, the waste of land, economic cost and environmental pollution due to the landfill of the wasted crushed stone powder may be prevented from being caused and fugitive dusts, which may cause pneumoconiosis due to a scatter of the crushed stone power near a working place, may be reduced.

In addition, since the crushed stone powder is alkaline, when the fertilizer using a crushed stone powder is used, the soil may be prevented from being acidified and the acidified soil may be neutralized.

### BRIEF DESCRIPTION OF THE DRAWINGS

FIG. 1 is a flowchart illustrating a method of manufacturing a fertilizer by using a crushed stone powder according to an embodiment of the present invention.

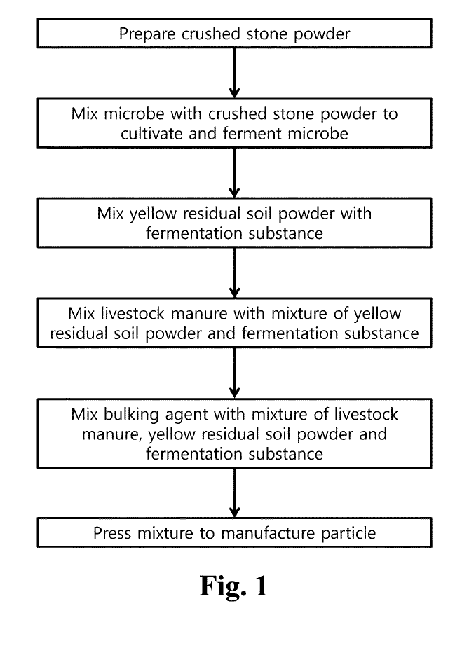

FIG. 2(a) is a photograph showing a treatment plot in which the fertilizer using a crushed stone powder according to the present invention is applied to cornus officinale and FIG. 2(b) is a photograph showing a reference plot in which in which the fertilizer using a crushed stone powder according to the present invention is not applied to cornus officinale.

### DETAILED DESCRIPTION OF THE INVENTION

Hereinafter, preferable embodiments of the present invention will be described in detail. Although the following embodiments according to the present invention will be described for illustrative purposes, but those skilled in the art will appreciate that various modifications, additions and substitutions are possible, without departing from the scope and spirit of the invention as disclosed in the accompanying claims.

First, a fertilizer using a crushed stone powder according to the present invention includes a crushed stone powder at a ratio of 10 wt % to 50 wt %, a microbe at a ratio of 1 wt % to 20 wt %, a yellow residual soil powder at a ratio of 10 wt % to 50 wt %, dried livestock manure at a ratio of 10 wt % to 20 wt %, and a bulking agent at a ratio of 10 wt % to 30 wt %.

In this case, the crushed stone powder has a diameter in a range of 0.01 μm to 30 μm and a specific surface area in a range of 5 m²/g to 45 m²/g. Thus, since the crushed stone powder contains a large quantity of components such as potassium (K), sodium (Na), calcium (Ca), magnesium (Mg), iron (Fe) and silicon (Si), inorganic substances may be supplied to crops. In this case, when the content of the crushed stone powder exceeds 50 wt %, the contents of materials except for the crushed stone powder including the microbe and livestock manure are reduced, so that the organic substance supply effect and the cohesive force may be reduced. When the content of the crushed stone powder is less than 10 wt %, the inorganic substance supply effect of the crushed stone powder may be reduced.

When the fertilizer is manufactured by using the crushed stone powder, the wasted crushed stone powder is utilized so that the waste may be reused. Further, the waste of land, economic cost and environmental pollution due to the landfill of the wasted crushed stone powder in the related art may be prevented from being caused and fugitive dusts, which may cause pneumoconiosis due to a scatter of the crushed stone power near a working place, may be reduced.

In addition, since the crushed stone powder is alkaline, when the fertilizer using a crushed stone powder is used, the soil may be prevented from being acidified and the acidified soil may be neutralized.

The microbe includes at least one selected from streptomyces albulus, pseudomonas cepacia, zymomonas mobilis, saccharomyces cerevisiae, and trichoderma viride.

The streptomyces albulus secretes ε-poly-llysine so that harmful microbes are inhibited from proliferating. In this case, a variant made by irradiating ultraviolet rays and treating chloramphenicol formulation may be added such that the streptomyces albulus is enabled to secrete ε-poly-llysine at the maximum.

In addition, the pseudomonas cepacia may decompose harmful components with soil microbes, and the zymomonas mobilis may prevent the glucose from being decomposed into alcohol. The saccharomyces cerevisiae produces a trace alcohol component, and the trichoderma viride decomposes a lignum and a fiber material to saccharify the lignum and fiber material.

By adding the microbe to the crushed stone powder, the crush stone powder is condensed or dissociated, so that the organic matters generated during the condensing or dissociating operation may supply nourishment to crops. In addition, since the crushed stone powder has a large surface area and is porous, the crushed stone powder has excellent microbe absorption and the microbes absorbed by the crushed stone powder is slowly eluted so that the growth and quality of crops may be consistently increased and the soil is improved due to the degradation action of microbe. Thus, the crushed stone powder may be utilized as a soil improvement agent.

In this case, when the content of the microbe exceeds 20 wt %, since the amount of the crushed stone powder by which microbes are absorbed is limited, it may be difficult to condense or dissociate the crushed stone powder and to improve the organic substance supply effect. When the content of the microbe is less than 1 wt %, the growth of crops and soil improvement may be deteriorated.

The yellow residual soil powder may have a diameter in the range of 0.01 μm to 30 μm. The yellow residual soil powder may be added in a clay state. The yellow residual soil power improves the condensability when the fertilizer using a crushed stone powder is manufacture and improves the solubility of the fertilizer when the fertilizer is used. In addition, the yellow residual soil powder encourages the growth of crops and prevents a plant from being acidified.

Since the livestock manure may supply nitrogen (N) and phosphorus (P) to crops, the fertilizer using a crushed stone powder according to the present invention, which includes potassium (K), may be utilized as crop nutritional supplements for supply potassium (K), nitrogen (N) and phosphorus (P) required for growing crops. The livestock manure may include pig manure, chicken manure, etc.

When the content of the livestock manure exceeds 20 wt %, nitrogen (N) and phosphorus (P) may be excessively supplied to crops, so that the crops may easily wither. When the content of the livestock manure is less than 10 wt %, it may be difficult to sufficiently supply nitrogen (N) and phosphorus (P).

The bulking agent includes at least one selected from a husk, sawdust, straw, scob and paste. In this case, the paste may be fabricated with flour, glutinous rice, etc. The bulking agent, which serves as medium of supplying oxygen, is called a diluent or a bulking member. The main components of the bulking agent include cellulose, hemicelluloses or lignin. When the bulking agent is mixed with an organic matter, excellent humus soil may be produced.

Hereinafter, a method of manufacturing a fertilizer by using a crushed stone powder will be described as follows.

First, a crushed stone powder having a content of moisture of 5% to 50% and at ratio of 10 wt % to 50 wt % is prepared.

A fermentation substance is obtained by cultivating and fermenting a primary mixture at temperature of 20° C. to 38° C. during 7 days to 90 days, where the primary mixture is obtained by mixing the crushed stone powder with a microbe at a ratio of 1 wt % to 20 wt %.

In this case, the microbe is prepared by freeze-drying the fungus bodies collected after the fungus bodies are cultivated at a cultivation place at temperature of 20° C. to 38° C. for a time of 68 hours to 76 hours.

A secondary mixture is obtained by mixing the fermentation substance with a yellow residual soil powder at a ratio of 10 wt % to 50 wt %.

A third mixture is obtained by mixing the secondary mixture with dried livestock manure at a ratio of 10 wt % to 20 wt %.

A fourth mixture is obtained by mixing the third mixture with a bulking agent at a ratio of 10 wt % to 30 wt %.

Then, the fourth mixture is pressed at a pressure of 50 kg/cm² to 500 kg/cm² so that the fourth mixture is prepared in the form of particles.

According to the fertilizer using a crushed stone powder and the method of manufacturing the same of the present invention, without using agricultural chemicals, nourishment may be suitably and uniformly supplied to crops with little manpower according to the growth periods of the crops. In addition, the quality of soil and the quality of crops may be improved.

### Embodiment 1

### Manufacture of Fertilizer Using Crushed Stone Powder

A crushed stone powder of 35 g having a content of moisture of 25% is prepared.

A fermentation substance is obtained by cultivating and fermenting a primary mixture, which is obtained by mixing the crushed stone powder with a microbe of 10 g, at 30° C. for 40 days.

In this case, after streptomyces albulus, pseudomonas cepacia, zymomonas mobilis, saccharomyces cerevisiae and trichoderma viride are cultivated at a cultivation place at 30° C. for 72 hours, the fungus bodies thereof are collected and freeze-dried, and 2 g of fungus bodies is mixed to prepare microbe.

A secondary mixture is obtained by mixing the fermentation substance with a yellow residual soil powder of 20 g.

A third mixture is obtained by mixing the secondary mixture with dried pig manure of 15 g.

A fourth mixture is obtained by mixing the third mixture with sawdust of 20.

The fourth mixture is pressed at the pressure of 250 kg/cm² so that the fourth mixture is prepared in the form of particles.

### Experimental Example 1

### Effect Comparison

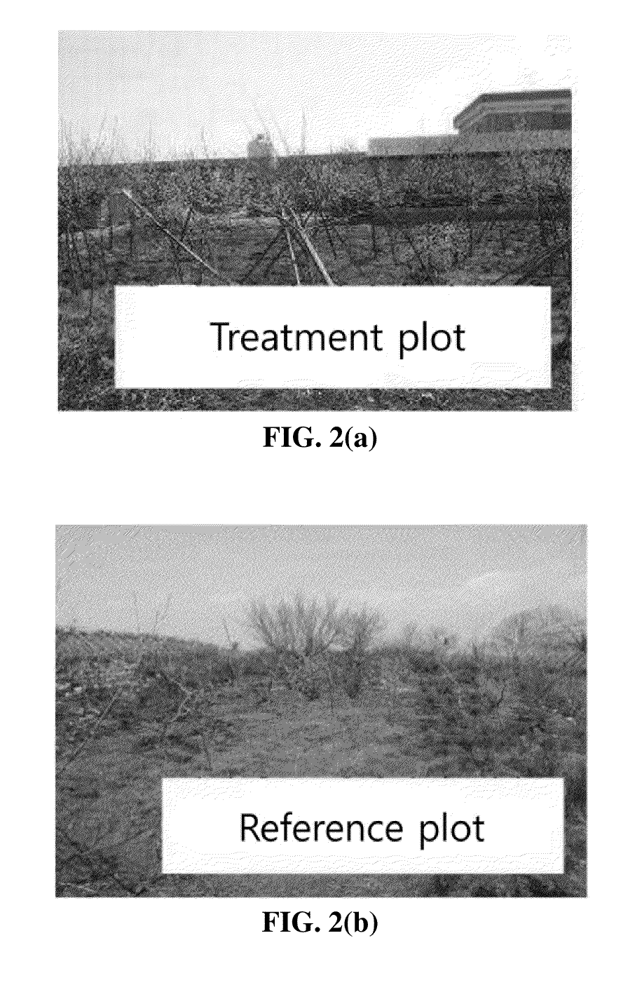

To investigate an effect of the fertilizer using a crushed stone power manufactured by the embodiment 1 of the present invention, a treatment plot has be set by applying the fertilizer using a crushed stone power of 10 g per one cornus officinale tree to one package of cornus officinale trees, that is, ten cornus officinale trees, and a reference plot has been set by preparing ten cornus officinale trees to which the fertilizer using a crushed stone power is not applied. Three years later, the growths of the cornus officinale trees of the treatment plot and the cornus officinale trees of the reference plot are shown in FIGS. 2(a) and 2(b).

Referring to FIGS. 2(a) and 2(b), it has been understood that the growth of the cornus officinale trees of the treatment plot (see FIG. 2(a)) is better than that of the cornus officinale trees of the reference plot (see FIG. 2(b)).

Therefore, the fertilizer using a crushed stone powder manufactured through the manufacturing method according to the present invention supplies nourishment required for growing crops and promotes the supply of nourishment, so that the growth and quality of crops are improved and soil is improved by the crushed stone powder and microbes. The fertilizer according to the present invention is not a chemical fertilizer, but a fertilizer obtained by mixing natural materials while reusing waste, so that the fertilizer according to the present invention is environment friendly and serves as a plant nutritional supplement and a soil improvement agent.

What is claimed is:

1. A fertilizer using a crushed stone powder, the fertilizer comprising:
a crushed stone powder at a ratio of 10 wt % to 50 wt %, a microbe at a ratio of 1 wt % to 20 wt %, a yellow residual soil powder at a ratio of 10 wt % to 50 wt %, dried livestock manure at a ratio of 10 wt % to 20 wt %, and a bulking agent at a ratio of 10 wt % to 30 wt %.

2. The fertilizer of claim 1, wherein the crushed stone powder has a diameter in a range of 0.01 μm to 30 μm and a specific surface area in a range of 5 m²/g to 45 m²/g.

3. The fertilizer of claim 1, wherein the microbe includes at least one selected from streptomyces albulus, pseudomonas cepacia, zymomonas mobilis, saccharomyces cerevisiae, and trichoderma viride.

4. The fertilizer of claim 1, wherein the bulking agent includes at least one selected from a husk, sawdust, straw, scob and paste.

5. A method of manufacturing a fertilizer by using a crushed stone powder, the method comprising:
preparing a crushed stone powder having a content of moisture of 5% to 50% and at ratio of 10 wt % to 50 wt %;
obtaining fermentation substance by cultivating and fermenting a primary mixture at temperature of 20° C. to 38° C. during 7 days to 90 days, wherein the primary mixture is obtained by mixing the crushed stone powder with a microbe at a ratio of 1 wt % to 20 wt %;
obtaining a secondary mixture by mixing the fermentation substance with a yellow residual soil powder at a ratio of 10 wt % to 50 wt %;
obtaining a third mixture by mixing the secondary mixture with dried livestock manure at a ratio of 10 wt % to 20 wt %;
obtaining a fourth mixture by mixing the third mixture with a bulking agent at a ratio of 10 wt % to 30 wt %; and
manufacturing particles by pressing the fourth mixture at a pressure of 50 kg/cm² to 500 kg/cm².
